(19) United States
(12) Patent Application Publication
(10) Pub. No.: US 2022/0260953 A1
(43) Pub. Date: Aug. 18, 2022

(54) APPARATUS FOR GENERATING HOLOGRAM AND A METHOD FOR GENERATING HOLOGRAM USING THE SAME

(71) Applicants: ELECTRONICS AND TELECOMMUNICATIONS RESEARCH INSTITUTE, Daejeon (KR); Kyungpook National University Industry-Academic Cooperation Foundation, Daegu (KR)

(72) Inventors: Ki Hong CHOI, Daejeon (KR); Joong Ki PARK, Daejeon (KR); Kee Hoon HONG, Daejeon (KR); Hak-Rin KIM, Daegu (KR); Su-Won LEE, Daegu (KR); Tae-Hyun LEE, Daegu (KR)

(73) Assignees: ELECTRONICS AND TELECOMMUNICATIONS RESEARCH INSTITUTE, Daejeon (KR); Kyungpook National University Industry-Academic Cooperation Foundation, Daegu (KR)

(21) Appl. No.: 17/674,468

(22) Filed: Feb. 17, 2022

(30) Foreign Application Priority Data
Feb. 18, 2021 (KR) 10-2021-0021894
Jan. 21, 2022 (KR) 10-2022-0009524

(51) Int. Cl. G03H 1/04; G02F 1/01

(52) U.S. Cl. CPC G03H 1/0443; G02F 1/0136; G03H 2223/20; G03H 2223/22; G03H 2001/0447

(57) ABSTRACT

Disclosed herein an apparatus for generating hologram and a method for generating hologram using the same. The apparatus includes: a geometric phase modulator disposed to enable incident light from a target object to pass through and configured to modulate the incident light to a plurality of circular polarizations; an image sensor configured to receive the plurality of circular polarizations and to acquire an interference fringe generated by the plurality of circular polarizations as an image; and a polarization selective element equipped with a liquid crystal element, which controls an output polarization angle of the incident light according to an output polarization signal, and configured to sequentially output the incident light at output polarization angles different from each other.

### CROSS REFERENCE TO RELATED APPLICATION

The present application claims priority to a Korean patent applications 10-2021-0021894, filed Feb. 18, 2021 and 10-2022-0009524, filed Jan. 21, 2022, the entire contents of which are incorporated herein for all purposes by this reference.

### BACKGROUND OF THE INVENTION

### Field of the Invention

The present disclosure relates to an apparatus and method for generating a hologram and, more particularly, to a self-interference hologram generating apparatus that acquires a hologram in real time and implements the hologram with a high resolution.

### Description of the Related Art

Unlike the conventional photography technology recording only intensity information of light, holography acquires and records amplitude and phase information of light propagated from an object. As of now, since there is no sensor capable of directly recording the amplitude and phase information of visible light, when the amplitude and phase information of visible light is acquired, relevant information may be indirectly acquired through interference of light. Interference is a phenomenon caused by an interaction of two light waves, an object beam and a reference beam, but an interference fringe is difficult to obtain without using a laser, which produces a beam with artificially aligned amplitude and phase, the holography technology has mainly used a laser until recently.

However, while using such a laser, all the other lights but the one from the laser should be blocked, so that no hologram can be actually taken and recorded in an external environment. To solve this practical problem, the self-interference holography technology has been developed.

Self-interference holography is capable of obtaining an interference fringe by a self-interference method that divides incident light emitted and reflected from an object according to spatial or polarization states. Under the influence of an interferometer or a polarizing modulator, light waves thus divided may be modulated to wave fronts with different values of curvature and be propagated so as to form an interference fringe on an image sensor. As the interference herein occurs between twin light waves that originate from light starting from the same space-time, it is free from the condition of a light source. Accordingly, shooting is possible under a fluorescent light, a light bulb, LED or natural light condition.

The concept of self-interference holography technology has been established, but there are only a few systems capable of actual implementations of the technology, and further a complicated optical system should be applied for separating incident light and forming an interference fringe, which makes it impossible for the technology to be applied to real products.

The holography technology, which arranges every optical component on a single axis, has an advantage of utilizing the resolution or area of an image sensor for a hologram, but according to the interference equation, information on light source and twin-image information of an object are recorded along with the hologram information of the object, which is a disadvantage. A phase-shifting technique is used to remove the light source and twin-image information from the hologram information thus obtained. When the optical path of an object beam or a reference beam is finely adjusted into 2 to 4 steps, each of which is shorter than a wavelength, phase information finely shifts, and when the intensity of light is measured and operated at each step, a complex hologram may be obtained with the light source and twin-image information being removed.

Various phase-shifting systems are attempted for phase shifting in holography technology, and as an example, an instrument for minutely moving an interferometer in nano units by means of piezoelectric elements is being used, or an optical modulator capable of phase modulation is being used. Nevertheless, those instruments are so expensive and also sensitive to external environments like temperature, humidity and vibration, and furthermore, as the optical path is directly modulated, phase can be modulated completely from 0 to 360 degrees only in a particular wavelength range but the phase-shifting error increases further away from a particular wavelength. In addition, a phase-shifting system may utilize a scheme of using a difference of optical path caused by media with different refractive indexes or a scheme of having different optical paths according to polarizing components due to birefringent elements.

Meanwhile, a phase-shifting system is applied in a manner to sequentially change the phase of light and obtains one complex hologram by combining a plurality of phase-shifted information at each step. However, a phase-shift time is required at each step to obtain one complex hologram. Accordingly, a hologram may be generated for a static object, but no hologram for a moving object may be obtained in real time. In addition, a polarization image sensor may be considered as a phase-shifting system, and a polarization image sensor is equipped with a micro polarizing plate arranged at a different angle in each pixel. A polarization image sensor processes and matches phase-shifted information and a micro polarizing plate at a different angle at each step. When processing is performed between phase information shifted at a specific angle and a corresponding micro polarizing plate, no micro polarizing plate at a different angle is used, which degrades the resolution of a complex hologram.

### SUMMARY

A technical object of the present disclosure is to provide a self-interference hologram generating apparatus and method that acquire and implement a hologram in real time and with a high resolution.

The technical objects of the present disclosure are not limited to the above-mentioned technical objects, and other technical objects that are not mentioned will be clearly understood by those skilled in the art through the following descriptions.

According to the present disclosure, there is provided an apparatus for generating a hologram, the apparatus comprising: a geometric phase modulator disposed to enable incident light from a target object to pass through and configured to modulate the incident light to a plurality of circular polarizations; an image sensor configured to receive the plurality of circular polarizations and to acquire an interference fringe generated by the plurality of circular polarizations as an image; and a polarization selective element equipped with a liquid crystal element, which controls an output polarization angle of the incident light according to an output polarization signal, and configured to sequentially output the incident light at output polarization angles different from each other.

According to the embodiment of the present disclosure in the apparatus, the polarization selective element may be sequentially disposed in a travel direction of the incident light and is configured as a plurality of cells set to output the incident light at polarization angles different from each other.

According to the embodiment of the present disclosure in the apparatus, each of the plurality of cells may be configured as a liquid crystal element having a half-wave plate characteristics and is controlled to have a same phase in a whole area.

According to the embodiment of the present disclosure in the apparatus, an independent cell control signal may be applied to each of the plurality of cells as the output polarization signal, and the output polarization angles may be determined according to the cell control signal applied to the each of the plurality of cells.

According to the embodiment of the present disclosure in the apparatus, the output polarization signal may be generated to sequentially control the output polarization angles of the incident light at a 90-degree interval.

According to the embodiment of the present disclosure in the apparatus, the image sensor may be further configured to receive the plurality of circular polarizations based on an exposure start signal, and the output polarization signal may be generated by being synchronized by the exposure start signal. According to the embodiment of the present disclosure in the apparatus, the plurality of cells may be configured as a liquid crystal element having a same liquid crystal mode, and the liquid crystal mode may employ any one of an optically compensated bend (OCB) mode, an electrically controlled birefringence (ECB) mode, a twisted nematic (TN) mode, a vertically aligned (VA) mode, and an in-plane switching (IPS) mode.

According to the embodiment of the present disclosure in the apparatus, the polarization selective element may be disposed in front of the geometric phase modulator, and the geometric phase modulator may be further configured to modulate the incident light, which is sequentially output at output polarization angles different from each other, to the plurality of circular polarizations respectively.

According to the embodiment of the present disclosure in the apparatus, the apparatus may further a linear polarizer disposed between the geometric phase modulator and the image sensor and be configured to shift the plurality of circular polarizations to a plurality of linear polarizations. The image sensor may be further configured to acquire an interference fringe generated by the plurality of linear polarizations as an image.

According to the embodiment of the present disclosure in the apparatus, the polarization selective element may be disposed behind the geometric phase modulator and further is configured to convert the plurality of circular polarizations, which are output from the geometric phase modulator, to a plurality of linear polarizations corresponding to the plurality of circular polarizations, and output the plurality of linear polarizations to the image sensor. Also, the image sensor may be further configured to acquire an interference fringe generated by the plurality of linear polarizations as an image.

According to another embodiment of the present disclosure, there is provided a method for generating a hologram, the method comprising: modulating, by a geometric phase modulator, incident light from a target object to a plurality of circular polarizations; receiving, by the image sensor, the plurality of circular polarizations and acquiring an interference fringe generated by the plurality of circular polarizations as an image; and outputting, by a polarization selective element equipped with a liquid crystal element which controls an output polarization angle of the incident light according to an output polarization signal, sequentially the incident light at output polarization angles different from each other.

According to another embodiment of the present disclosure, there is provided a polarization selective element. The polarization selective element comprises a liquid crystal element composed of a plurality of cells, which are sequentially disposed in a travel direction of incident light, in order to control output polarization angles of the incident light from a target object according to an output polarization signal. The polarization selective element outputs sequentially the incident light at the output polarization angles different from each other, which are determined based on a cell control signal as the output polarization signal applied independently to each of the plurality of cells.

The features briefly summarized above for this disclosure are only exemplary aspects of the detailed description of the disclosure which follow, and are not intended to limit the scope of the disclosure.

The present disclosure may provide a self-interference hologram generating apparatus and method that acquire and implement a hologram in real time and with a high resolution.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a block diagram showing a configuration of a hologram generating device according to an embodiment of the present disclosure.

FIG. 2A to FIG. 2E are views illustrating liquid crystal modes applicable to cells constituting a polarization selective element.

FIG. 3 is a flowchart for a method of generating a hologram according to another embodiment of the present disclosure.

FIG. 4 is a table exemplifying cell control signals applied to first and second OCB cells and corresponding output polarization.

FIG. 5 is a schematic diagram of a first conventional hologram generating device using a rotary polarizing plate as a phase-shifting element.

FIG. 6 is a schematic diagram of a second conventional hologram generating device using a variable wave plate as a phase-shifting element.

FIG. 7 is a schematic diagram of a third conventional hologram generating device using a polarization image sensor as a phase-shifting element.

FIG. 8 is a table for comparing performance between the first to third conventional hologram generating devices and a hologram generating device according to the present embodiment.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

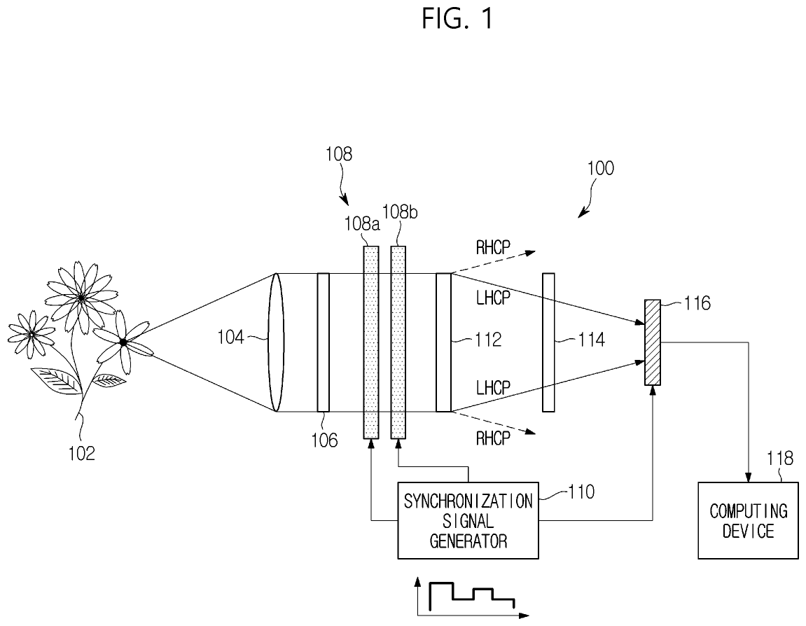

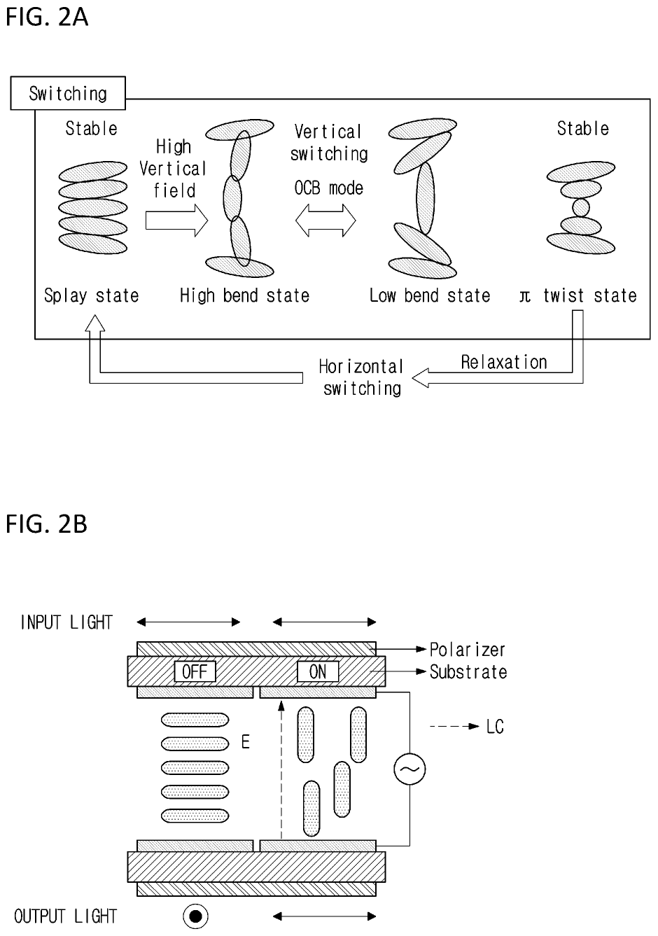

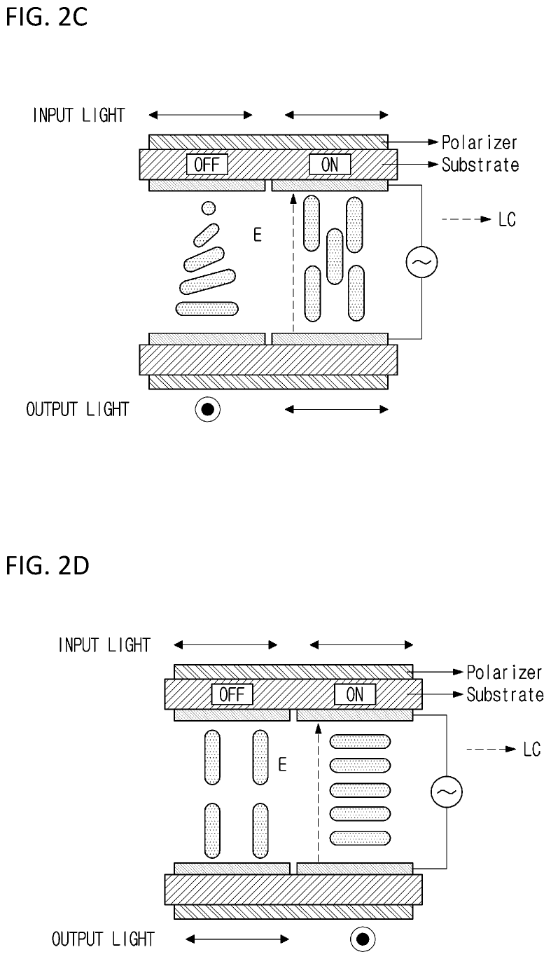

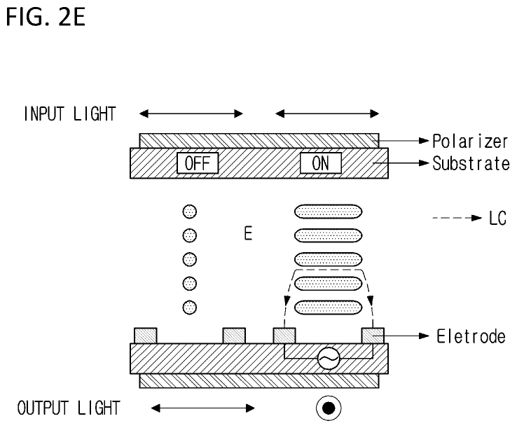

Hereinafter embodiments of the present disclosure will be described with reference to FIG. 1 and FIGS. 2A-2E.

FIG. 1 is a block diagram showing a configuration of a hologram generating device according to an embodiment of the present disclosure.

A hologram generating device 100 may be a self-interference holographic system that obtains and generates an interference fringe from incident light propagated from a target object 102 in a self-interference scheme.

The hologram generating device 100 may include, along an optical axis on which incident light from the target object 102 travels, an objective lens 104, a first linear polarizer, a polarization selective element 108, a geometric phase modulation unit (geometric phase modulator) 112, a second linear polarizer 114, and an image sensor 116. In addition, the hologram generating device 100 may be equipped with a synchronization signal generator 110 capable of generating and transmitting an output polarization signal and an exposure start signal applied to the polarization selective element 108 and the image sensor 116 and a computing device 118 capable of acquiring and processing a hologram image based on an interference fringe received from the image sensor 116.

The objective lens 104 may gather light incident from a target object, while making the light pass, and deliver the light to a first linear polarizer 106.

The first linear polarizer 106 is disposed behind the objective lens and may modulate the incident light so as to filter linear polarization capable of interference from the incident light. For example, the first linear polarizer 106 may be composed of a linear polarizing plate.

The polarization selective element 108 is disposed behind the first linear polarizer 106 and may output linear polarized incident light at output polarization angles set different from each other according to an output polarization signal applied from the synchronization signal generator 110.

In the case of holography technology, both information on a light source and information on twin-image are recorded in the image sensor 106 that obtains a hologram image through an interference fringe, and those pieces of information may become noise. Accordingly, in order to remove the information on the light source and the information on the twin-image from the hologram image, the polarization selective element is provided and may function as a phase-shifting means. This may be described in detail as follows.

|ψ₁+ψ₂|²=|ψ₁|²+|ψ₂|²+ψ₁ψ*₂+ψ*₁ψ₂ Equation (1)

In an on-axis structure of parallel arrangement along an optical path of the device 100, when interference of two wave fronts occurs, four terms are derived as shown in Equation (1). ψ denotes a complex hologram, and 1 and 2 represent respective wave fronts.

In Equation (1), the first and second terms are bias representing brightness information of each wave front, and the last term is a conjugate image or twin-image of desired complex optical information. These pieces of information are factors detrimental to clearly extracting only the third term of the desired complex optical information, and as they are completely overlapping in space, if they have a complicated shape, one interference fringe is not sufficient to perfectly extract the desired complex optical information. In order to obtain the desired complex optical information, the polarization selective element 108 embodies phase shifting that changes a portion of phase between two interfering wave fronts, so that the geometric phase modulation unit 112 and the image sensor 116 become capable of obtaining multiple sheets of interference fringes and of combining a plurality of interference fringes.

That is, the polarization selective element 108 may change a phase for incident light transmitted to the geometric phase modulation unit 112. The polarization selective element 106 may be configured not by a phase-shifting scheme, which directly changes an optical path, but by a geometric phase-shifting scheme that changes a phase while maintaining an optical path. Thus, as the polarization selective element 108 is not dependent on a phase shift caused by a change of path, a phase-shifting effect with smaller error may be gained in every wavelength range.

Specifically, in order to output linear polarized incident light at different output polarization angles, the polarization selective element 108 may have a liquid crystal element capable of controlling an output polarization angle of incident light.

The polarization selective element 108 may be sequentially disposed in the travel direction of incident light and include a plurality of cells set to output the incident light at different output polarization angles. In the present disclosure, to output incident light at four output polarization angles, the polarization selective element 108 may be configured as two cells 108a and 108b with a predetermined liquid crystal mode. Herein, the first and second cells 108a and 108b may be set to have different initial alignment angles in order to enable different phase modulations. In addition, when the first and second cells 108a and 108b are turned off respectively, linear polarized light passing through each cell may be output at different output polarization angles. When the first and second cells 108a and 108b are turned on respectively, linear polarized light passing through each cell may be output at different output polarization angles. Accordingly, the polarization selective element 108 consisting of the two cells 108a and 108b may have four output polarization angles based on respective combinations of the cells being turned on or off. The present disclosure exemplifies a polarization selective element composed of two cells. However, the present disclosure is not limited thereto, and three or more cells may be disposed so that incident light is output at any other number of output polarization angles than the above-described number.

The first and second cells 108a and 108b may be composed of liquid crystal elements with half-wave plate features. The first and second cells 108a and 108b may be controlled to have a same phase in a whole region respectively, when output polarization signals, for example, first and second cell control signals are applied. Accordingly, incident light may be output at a uniform output polarization angle across the polarization selective element 108.

The plurality of cells 108a and 108b may be composed of liquid crystal elements with a same liquid crystal mode. As exemplified in FIG. 2A to FIG. 2E, any one of an optically compensated bend (OCB) mode, an electrically controlled birefringence (ECB) mode, a twisted nematic (TN) mode, a vertically aligned (VA) mode, and an in-plane switching (IPS) mode may be employed as a liquid crystal mode applied to the cells 108a and 108b. FIG. 2A to FIG. 2E are views illustrating liquid crystal modes applicable to cells constituting a polarization selective element. The present disclosure lists the above-described examples of liquid crystal modes but is not limited thereto. FIG. 2A illustrates an optically compensated bend (OCB) mode applicable to the cells 108a and 108b.

The first and second cells 108a and 108b of the polarization selective element 108 may be configured as a first OCB cell and a second OCB cell that are output at output polarization angles different from each other. The first and second OCB cells may have a liquid crystal mode of OCB respectively. In order to enable different phase modulations, the first and second OCB cells may be set to have different initial alignment angles, for example, 45 degrees and 67.5 degrees respectively.

An operation principle of an OCB cell will be described with reference to FIG. 2A.

A liquid crystal element may control a polarized light by electrically modulating an optical axis direction of liquid crystal or optical anisotropy of liquid crystal, that is, a size of birefringence, so that gradation of optical transmittance or reflectance of the liquid crystal element may be changed. A mode of a liquid crystal element may be determined by a direction, in which liquid crystal moves, through an arrangement structure of initial liquid crystal and an electrode structure determining a direction of an electric field.

An OCB cell may be a type with an improved viewing angle obtained by attaching an optical compensation film to a pi cell structure. A pi cell rubs liquid crystal with a positive dielectric constant on an alignment layer having a little pretilt angle and then bonds upper and lower plates to be horizontally aligned. As illustrated in FIGS. 2A-2E, an initial state of liquid crystal may be a splay state. When applying a vertical high voltage to this state, the splay state may be shifted to a bend state. In this case, when an electric field is removed, liquid crystals may shift to a 180-degree twist state. When constantly applying an initial voltage a little higher than a voltage expected to shift a bend state to a 180-degree twist state, the bend state may be maintained. Herein, a bend state with a low pretilt angle may be referred to as a low bend state, and a bend state with a high pretilt angle, which is obtained by applying a high voltage, may be referred to as a high bend state. An OCB mode may be a mode of switching between the low bend state and the high bend state. As upper liquid crystals and lower liquid crystals move in a same direction during the switching, there is actually no friction caused by fluid flow (the flow direction of liquid crystals) in the middle of cell thickness. Consequently, as the on-off response time is as fast as about 1 ms, a very fast response feature is obtained.

FIG. 2B illustrates an ECB mode applicable to the cells 108a and 108b. The first and second cells 108a and 108b may be composed of a first OCB cell and a second OCB cell that are output at output polarization angles different from each other.

An operation of an ECB cell will be described with reference to FIG. 2B. A liquid crystal of an ECB cell is the same as an alignment axis direction of a substrate, and when an electric field is applied to a liquid crystal layer, the liquid crystal may be aligned in the same direction as a direction of the electric field. A retardation of the liquid crystal layer is a half-wave (Π) condition, and when a polarization direction of incident light forms a 45-degree angle with the alignment direction of the liquid crystal, if the ECB cell is turned off, an output polarization direction of the incident light may rotate 90 degrees. When the ECB cell is turned on, the output polarization direction of the incident light may be maintained without change.

FIG. 2C illustrates a twisted nematic (TN) mode applicable to the cells 108a and 108b. The first and second cells 108a and 108b may be composed of a first TN cell and a second TN cell that are output at output polarization angles different from each other.

An operation of a TN cell will be described with reference to FIG. 2C. When being turned off, top and lowest liquid crystals of the TN cell may be arranged to be perpendicular to each other. When being turned off, twist of liquid crystals is off and the liquid crystals may be aligned in a direction of an electric field. When the TN cell is turned off, an output polarization direction of incident light may rotate 90 degrees. When the TN cell is turned on, the output polarization direction of the incident light may be maintained without change.

FIG. 2D illustrates a vertically aligned (VA) mode applicable to the cells 108a and 108b. The first and second cells 108a and 108b may be composed of a first VA cell and a second VA cell that are output at output polarization angles different from each other.

An operation of a VA cell will be described with reference to FIG. 2D. When being turned off, a liquid crystal of the VA cell may be so aligned as to be perpendicular to a substrate. When being turned on, the liquid crystal may be so aligned as to be perpendicular to a direction of an electric field. When the VA cell is turned off, an output polarization direction of incident light may be maintained without change. A retardation of the liquid crystal layer is a half-wave (Π) condition, and when a polarization direction of incident light forms a 45-degree angle with the alignment direction of the liquid crystal, if the VA cell is turned on, an output polarization direction of the incident light may rotate 90 degrees.

FIG. 2E illustrates an in-plane switching (IPS) mode applicable to the cells 108a and 108b. The first and second cells 108a and 108b may be composed of a first IPS cell and a second IPS cell that are output at output polarization angles different from each other.

An operation of an IPS cell, which adopts a positive liquid crystal as a liquid crystal type to be used, will be described with reference to FIG. 2E. When being turned off, liquid crystals of the IPS cell may be arranged in a same direction as an alignment axis of substrate. When being turned on, the liquid crystals may be aligned in a rotating direction at 45 degrees with respect to a direction of an electric field. When the IPS cell is turned off, an output polarization direction of incident light may be maintained without change. A retardation of the liquid crystal layer is a half-wave (Π) condition, and when a polarization direction of incident light forms a 45-degree angle with the alignment direction of the liquid crystal, if the IPS cell is turned on, an output polarization direction of the incident light may rotate 90 degrees.

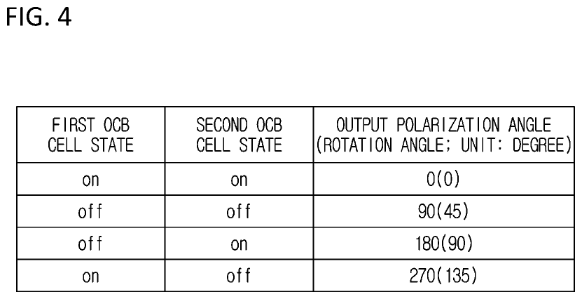

Meanwhile, as output polarization signals generated by the synchronization signal generator 110, independent cell control signals may be applied to the first and second cells 108a and 108b respectively. Accordingly, as exemplified in FIG. 4, an output polarization angle may be determined according to first and second cell control signals applied to the first and second cells 108a and 108b respectively. Besides, the output polarization signals, that is, the first and second cell control signals may be generated so as to sequentially control output polarization angles of incident light at a 90-degree interval. Thus, the geometric phase modulation unit 112 and the image sensor 116 may obtain and combine (phase-shifted) interference fringes selected at angles in 4 steps.

In order to generate a hologram in real time, the synchronization signal generator 110 may generate first and second cell control signals by synchronizing the first and second cell control signals with an exposure start signal of the image sensor 116.

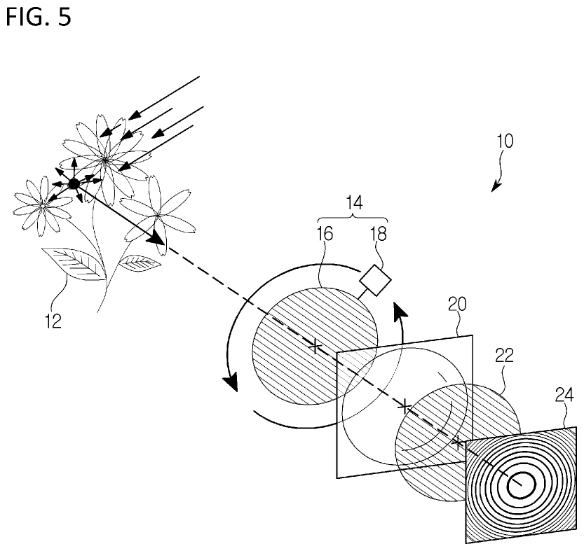

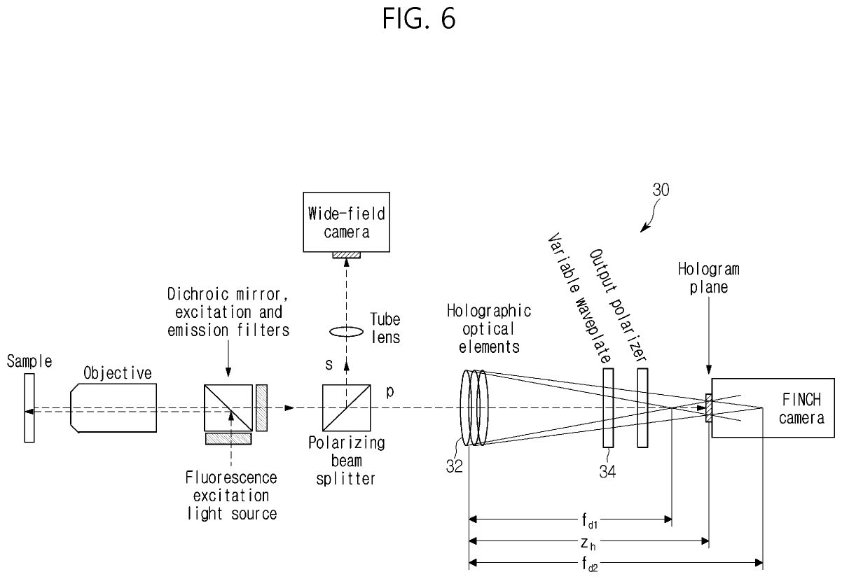

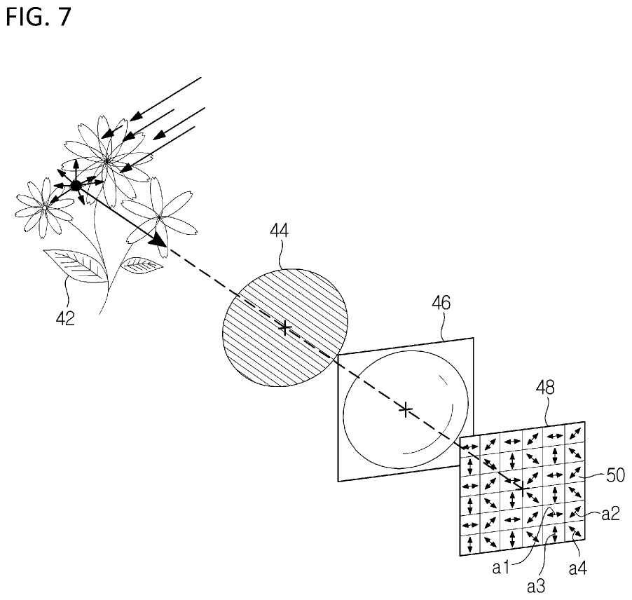

Unlike a first conventional device using a rotary polarizing plate in FIG. 5, the polarization selective element 108 according to the present disclosure is not accompanied by any mechanical rotation and thus may acquire a hologram in real time and acquire a hologram of a moving object. In addition, unlike a second conventional device in FIG. 6, which is incapable of acquiring a hologram in real time because of the opening and response speed of a variable waveplate, the polarization selective element 108 of the present disclosure is capable of acquiring a hologram in real time since it outputs a selected polarization in synchronization with the exposure of the image sensor 116. Unlike a third conventional device using a polarization image sensor in FIG. 7, the polarization selective element 108 of the present disclosure has selectivity of polarization, and as the image sensor 116 does not require any separate polarization selective element, it may have a higher resolution than the third conventional device.

The geometric phase modulation unit 112 may modulate incident lights, which are sequentially output at an output polarization angle selected by the polarization selective element 108, into a plurality of circular polarizations respectively. The plurality of circular polarizations may be left-handed circular polarization (LHCP) and right-handed circular polarization (RHCP). An interference fringe may be generated by interference of LHCP and RHCP modulated by the geometric phase modulation unit 112.

The geometric phase modulation unit 112 may be any one of a geometric phase lens, a phase-only spatial light modulator (SLM), a birefringence lens, and a liquid crystal lens. For example, when the geometric phase modulation unit 112 is a geometric phase lens, a liquid crystal may be an element that maintains a specific fixed arrangement and functions as a lens. A general lens may realize dynamic phase modulation capable of convergence and divergence by adjusting thickness of media with different refractive indexes and modulating a wave front of incident light. A geometric phase lens is different in that phase shifting into a polarization state of light occurs according to a birefringence feature of liquid crystal and thus a wave front of incident light is modulated. As a hologram shooting technique is used to fabricate a geometric phase lens, twin-images of a lens surface to be recorded may be recorded together and may show a lens feature of having both negative and positive focal distances.

A geometric phase lens may function as an independent passive optical element since it needs not electrically move a liquid crystal element but is permanently aligned along an alignment layer formed by hardening of photosensitive polymer.

In addition, when incident lights are right-handed circular polarizations, they may be converted to left-handed circular polarizations and converge according to a positive focal distance, and when incident lights are left-handed circular polarizations, they may be converted to right-handed circular polarizations and diverge according to a negative focal distance. When unpolarized light or linear-polarized light is incident, energy is divided into halves, which converge and diverge, and as shown in FIG. 1, a convergent light may become a left-handed circular polarization (LHCP), and a divergent light may become a right-handed circular polarization (RHCP).

For reference, a circular polarization means that an electric displacement vector (or magnetic field displacement vector) of a light wave has a direction of circular oscillation, and when a linear polarization is incident with a 45 degree-tilted oscillation plane with respect to a main axis of a ¼ wave plate, light passing through the ¼ wave plate is a circular polarization. A circular polarization, in which an electric vector of light rotates clockwise from an observer's perspective, is referred to as a right-handed circular polarization, and a circular polarization rotating counter-clockwise is referred to as a left-handed circular polarization.

The second linear polarizer 114 is disposed behind the geometric phase modulation unit 112 and may shift an LHCP and a RHCP to corresponding linear polarizations respectively. Interference of LHCP and RHCP may be further enforced as the second linear polarizer 114 changes the LHCP and RHCP, which have been converted through the geometric phase modulation unit 112, to a same linear polarization, and thus a clearer interference fringe may be generated in the image sensor 116. For example, the second linear polarizer 114 may be composed of a linear polarizing plate.

The image sensor 116 may receive 2 linear polarizations converted from a left-handed circular polarization (LHCP) and a right-handed circular polarization (RHCP) and may acquire an interference fringe generated by the circular polarizations as an image. The image sensor 116 may acquire an interference fringe as an image by sequentially receiving pulses according to an exposure start signal applied in the synchronization signal generator 110. In order to acquire a hologram in real time, the synchronization signal generator 110 may generate an exposure start signal and first and second cell control signals by synchronizing these signals.

As described above, in order to enable the polarization selective element 108 to sequentially have output polarization angles at 90-degree intervals, when incident light is output, 4 interference fringes are combined which are phase-shifted at 90-degree intervals (Π/2), and each of the 4 interference fringes may be obtained by Equation 2. Equation 3 describes a process of combining and converting 4 images thus obtained to one piece of complex optical information data. Π denotes a complex hologram, 1 and 2 represent respective wave fronts, and I refers to a phase-shifted image at a 90-degree interval.

I₀=|ψ₁+ψ₂e^{j×0}|²=|ψ₁|²+|ψ₂|²+ψ₁ψ*₂+ψ*₁ψ₂ I_{π/2}=|ψ₁+ψ₂e^{j+π/2}|²=|ψ₁|²+|ψ₂|²+jψ₁ψ*₂−jψ*₁ψ₂ I_{π}=|ψ₁+ψ₂e^{j×π}|²=|ψ₁|²+|ψ₂|²−ψ₁ψ*₂+ψ*₁ψ₂ I_{3π/2}=|ψ₁+ψ₂e^{j×3π/2}|²=|ψ₁|²+|ψ₂|²−jψ₁ψ*₂+jψ*₁ψ₂ [Equation 2]

ψ₁ψ*₂ ∝ (I₀−I_{π})−j(I_{π/2}−I_{3π/2}) [Equation 3]

The hologram generating device according to the present disclosure may acquire information on incident light through information on an interference fringe obtained by the image sensor 116. That is, a hologram image may be obtained through an interference fringe obtained by the image sensor 116. The computing device 118 may display the hologram image thus obtained through a separate hologram display device, and the hologram display device may be applied in various ways.

In present embodiment, the polarization selective element 108 is described to be disposed in front of the geometric phase modulation unit 112, but in another embodiment, the polarization selective element 108 may be disposed behind the geometric phase modulation unit 112. In this case, the polarization selective element 108 may be located between the geometric phase modulation unit 112 and the second linear polarizer 114.

According to the modified embodiment, the polarization selective element 108 may convert a left-handed circular polarization (LHCP) and a right-handed circular polarization (RHCP), which are output from the geometric phase modulation unit 112, to respective corresponding linear polarizations and thus output a plurality of linear polarizations in the image sensor 116. Accordingly, the image sensor 116 may acquire an interference fringe generated by a plurality of linear polarizations as an image.

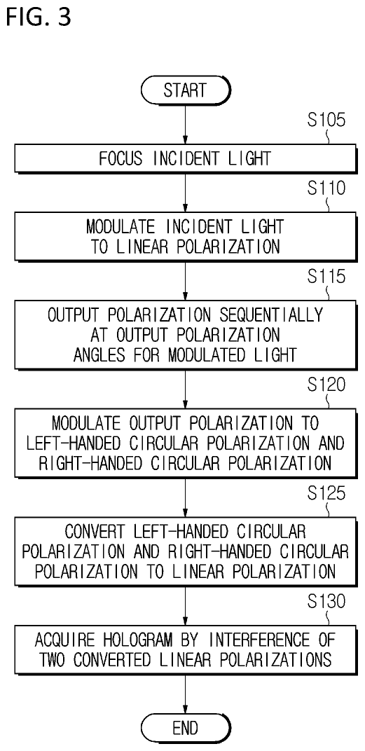

Hereinafter a method of generating a hologram according to another embodiment of the present disclosure will be described with reference to FIG. 1, FIG. 3 and FIG. 4. The method of generating a hologram will be described as an example method using the hologram generating device 100 described through FIG. 1.

FIG. 3 is a flowchart for a method of generating a hologram according to another embodiment of the present disclosure.

First, the objective lens 104 may focus incident lights propagated from the target object 102 and deliver the incident lights to the first linear polarizer 106 (S105).

The first linear polarizer 106 may modulate the incident lights so as to filter linear polarization capable of interference from the incident lights (S110).

Next, the polarization selective element 108 may polarize and output the incident lights by shifting phases of the incident lights modulated at predetermined output polarization angles (S115).

The polarization selective element 108 may be equipped with a liquid crystal element capable of controlling an output polarization angle of incident light according to an output polarization signal. The polarization selective element 108 may include the first cell 108a and the second cell 108b that have any one of the liquid crystal modes exemplified through FIG. 2A to FIG. 2E. The first and second cells 108a and 108b may be set to have different initial alignment angles in order to enable different phase modulations, and the first and second cells 108a and 108b may be composed of a liquid crystal element having a half-wave plate feature.

Herein, as output polarization signals generated by the synchronization signal generator 110, independent cell control signals may be applied to the first and second cells 108a and 108b respectively. Also, in order to generate a hologram in real time, the synchronization signal generator 110 may generate first and second cell control signals by synchronizing the first and second cell control signals with an exposure start signal of the image sensor 116. When the first and second cells 108a and 108b are composed of an OCB cell, an output polarization angle according to first and second cell control signals is exemplified in FIG. 4. Even when the first and second cells 108a and 108b are composed of different liquid crystal modes, an operation of first and second control signals and an output polarization angle may be implemented in a similar way as exemplified in FIG. 4.

FIG. 4 is a table exemplifying cell control signals applied to first and second OCB cells and corresponding output polarization. An output polarization angle may be determined according to first and second cell control signals (on, off) applied to the first and second cells 108a and 108b respectively. In order to control output polarization angles of incident light sequentially at a 90-degree interval, first and second cell control signals may be generated in accordance with a rotation angle of a polarizing plate implemented as the first and second cells 108a and 108b. As exemplified in FIG. 4, the first and second cell control signals may be so generated as to sequentially set the rotation angle to 0, 45, 90 and 135 degrees. Thus, the geometric phase modulation unit 112 and the image sensor 116 may obtain and combine (phase-shifted) interference fringes selected at angles in 4 steps.

Next, the geometric phase modulation unit 112 may modulate incident lights, which are sequentially output at an output polarization angle in the polarization selective element 108, into a left-handed circular polarization (LHCP) and a right-handed circular polarization (RHCP) respectively (S120).

Next, in order to reinforce an interference phenomenon of the LHCP and the RHCP, the second linear polarizer 114 may convert the LHCP and the RHCP to corresponding linear polarizations respectively (S125).

Next, the image sensor 116 may receive the 2 linear polarizations by sequentially receiving exposure start signals synchronized with first and second cell control signals and may obtain an interference fringe generated by the circular polarizations as an image (S130). An exposure start signal may be a pulse signal generated by the synchronization signal generator 110.

In present embodiment, the polarization selective element 108 is described to be disposed in front of the geometric phase modulation unit 112, but in another embodiment, the polarization selective element 108 may be disposed behind the geometric phase modulation unit 112. In this case, the polarization selective element 108 may be located between the geometric phase modulation unit 112 and the second linear polarizer 114.

According to a modified embodiment, the step S120 may precede the step S115. Accordingly, the polarization selective element 108 may convert a left-handed circular polarization (LHCP) and a right-handed circular polarization (RHCP), which are output from the geometric phase modulation unit 112, to respective corresponding linear polarizations and thus output a plurality of linear polarizations in the image sensor 116. Accordingly, the image sensor 116 may acquire an interference fringe generated by a plurality of linear polarizations as an image.

Hereinafter, with reference to FIG. 5 to FIG. 8, the advantages of the hologram generating device according to the present disclosure will be described by comparing the performance of conventional hologram generating devices and the hologram generating device according to present embodiment.

FIG. 5 is a schematic diagram of a first conventional hologram generating device using a rotary polarizing plate as a phase-shifting element.

The first conventional hologram generating device 10 includes a polarization selective element 14, which includes a polarizing plate rotation driving unit 18 that rotates a rotary polarizing plate 16 and a polarizing plate 16, a geometric phase lens 20, a fixed polarizing plate 22, and an image sensor 24.

The polarizing plate rotation driving unit 18 is configured to sequentially rotate the rotary polarizing plate 16 at 45 degrees so that the rotary polarizing plate 16 outputs polarizations obtained by sequential phase-shifting at a 90-degree interval for incident light of a target object 12. The geometric phase lens 20 modulates a linear polarization, which is converted through the polarization selective element 14, to a left-handed circular polarization and a right-handed circular polarization. The fixed polarizing plate 22 changes the left-handed circular polarization and the right-handed circular polarization to linear polarizations. The image sensor 24 may sequentially obtain an interference fringe by interference of circular polarizations sequentially received and may generate a complex hologram.

FIG. 6 is a schematic diagram of a second conventional hologram generating device using a variable waveplate as a phase-shifting element.

The second conventional hologram generating device 30 implements a self-interference optical system and a phase-shift element (polarization selective element) by using a birefringent lens 32 and a variable waveplate 34. As the birefringent lens 32 has different focal distances according to a polarization state of incident light, it is used as a polarization selective wave front modulation element. As the variable polarizing plate 34 assigns a phase difference to two light waves with modulated wave fronts, a series of phase-shifted interference fringes are obtained, and a complex hologram is extracted.

FIG. 7 is a schematic diagram of a third conventional hologram generating device using a polarization image sensor as a phase-shifting element.

The third conventional hologram generating device 40 includes a fixed polarizing plate 44, a geometric phase lens 46, and polarization image sensors 48 and 50.

The fixed polarizing plate 44 changes incident light of a target object 42 to linear polarization. The geometric phase lens 46 modulates the linear polarization to a left-handed polarization and a right-handed polarization. The polarization image sensors 48 and 50 function as a polarization selective element and include a micro polarizing plate array 48 attached to a front face of an image sensor. The micro polarizing plate array 48 is so formed that a plurality of micro polarizing plates 50 capable of converting transmitted light to linear polarization are arranged in corresponding splitting areas of the image sensor respectively. The image sensor has a plurality of pixels, and a splitting area for the image sensor may be formed in a pixel unit, and the micro polarizing plates 50 are formed to correspond to respective pixels of the image sensor. Herein, light transmittance axes a1, a2, a3 and a4 of the micro polarizing plates 50 are formed to have different angles so that phases of the linear polarization converted through the micro polarizing plates 50 are different from each other in each of the micro polarizing plates 50. Specifically, as illustrated in FIG. 7, the angles of the light transmittance axes a1, a2, a3 and a4 of the micro polarizing plate 50 may be formed to have any one of 4 different types of light transmittance axis angles that change in sequence at 45-degree intervals. Thus, linear polarizations converted through each of the micro polarizing plates 50 have a phase difference according to angles of the light transmittance axes a1, a2, a3 and a4. 2 linear polarizations converted through the micro polarizing plates 50 are received by the image sensor, while being in a polarized state. Herein, an interference fringe is generated by interference of the 2 linear polarizations converted from the left-handed circular polarization and the right-handed circular polarization, and the interference fringe thus generated is obtained by the image sensor.

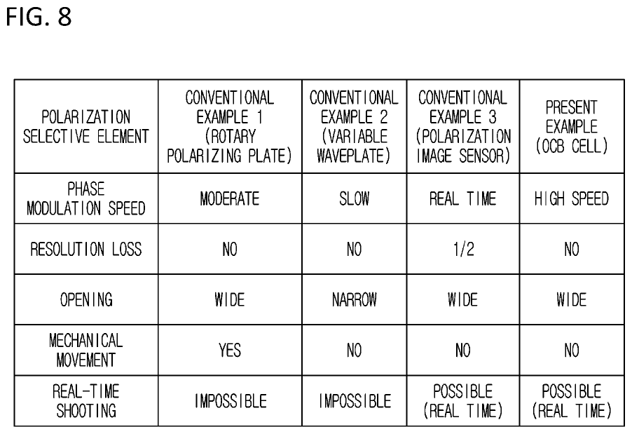

FIG. 8 is a table for comparing performance between the first to third conventional hologram generating devices and a hologram generating device according to present embodiment.

The first to third conventional devices 10, 30 and 40 are devices illustrated in FIG. 5 to FIG. 7. Present embodiment is the hologram generating device described through FIG. 1 and employs OCB cells as cells of a polarization selective element.

In the conventional hologram generating device and the hologram generating device according to present embodiment, a polarizing selective element is configured to sequentially output polarizations at a 90-degree interval. In present embodiment, as shown in FIG. 4, the synchronization signal generator 110 generates first and second cell control signals to sequentially control states of first and second OCB cells in 4 steps.

Referring to FIG. 8, in the case of a rotary polarizing plate according to the first conventional device 10, the phase modulation speed is lowered than the one in present embodiment because of the mechanical rotation of the polarizing plate. Due to mechanical rotation and slow phase modulation, the first conventional device 10 is incapable of shooting a target object in motion in real time.

In addition, in the case of a variable wave plate according to the second conventional device 30, it may be known that, as it is difficult to have a spatially uniform phase retardation value, an opening is formed to be narrow. It may be known through FIG. 8 that liquid crystal moves so slowly in the second conventional device that the phase modulation speed is low. Accordingly, when shooting through 4-step phase shifting, if a target object moves, an interference fringe has so drastic a change that real-time shooting is impossible.

In the case of a polarization image sensor according to the third conventional device 40, polarization phases are so different in each micro polarizing plate that not all the pixels of the image sensor are available, and thus, as identified in FIG. 8, the resolution of a final complex hologram is lost by ½ compared with present embodiment using every pixel, which is a disadvantage.

Present embodiment may implement sequential control of the states of first and second OCB cells in 4 steps at a high speed, and an exposure start signal of the image sensor 116 may be synchronized with first and second cell control signals. Accordingly, as shown in FIG. 8, by driving the OCB cells 108a and 108b and the image sensor 116 at a speed as fast as several ms, present embodiment may realize a high resolution, while obtaining a hologram in almost real time.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. An apparatus for generating a hologram, the apparatus comprising:
a geometric phase modulator disposed to enable incident light from a target object to pass through and configured to modulate the incident light to a plurality of circular polarizations;
an image sensor configured to receive the plurality of circular polarizations and to acquire an interference fringe generated by the plurality of circular polarizations as an image; and
a polarization selective element equipped with a liquid crystal element, which controls an output polarization angle of the incident light according to an output polarization signal, and configured to sequentially output the incident light at output polarization angles different from each other.

2. The apparatus of claim 1, wherein the polarization selective element is sequentially disposed in a travel direction of the incident light and is configured as a plurality of cells set to output the incident light at polarization angles different from each other.

3. The apparatus of claim 2, wherein each of the plurality of cells is configured as a liquid crystal element having a half-wave plate characteristics and is controlled to have a same phase in a whole area.

4. The apparatus of claim 2, wherein an independent cell control signal is applied to each of the plurality of cells as the output polarization signal, and
wherein the output polarization angles are determined according to the cell control signal applied to the each of the plurality of cells.

5. The apparatus of claim 1, wherein the output polarization signal is generated to sequentially control the output polarization angles of the incident light at a 90-degree interval.

6. The apparatus of claim 1, wherein the image sensor is further configured to receive the plurality of circular polarizations based on an exposure start signal, and
wherein the output polarization signal is generated by being synchronized by the exposure start signal.

7. The apparatus of claim 2, wherein the plurality of cells is configured as a liquid crystal element having a same liquid crystal mode, and
wherein the liquid crystal mode employs any one of an optically compensated bend (OCB) mode, an electrically controlled birefringence (ECB) mode, a twisted nematic (TN) mode, a vertically aligned (VA) mode, and an in-plane switching (IPS) mode.

8. The apparatus of claim 1, wherein the polarization selective element is disposed in front of the geometric phase modulator, and
wherein the geometric phase modulator is further configured to modulate the incident light, which is sequentially output at output polarization angles different from each other, to the plurality of circular polarizations respectively.

9. The apparatus of claim 8, further comprising a linear polarizer disposed between the geometric phase modulator and the image sensor and configured to shift the plurality of circular polarizations to a plurality of linear polarizations,
wherein the image sensor is further configured to acquire an interference fringe generated by the plurality of linear polarizations as an image.

10. The apparatus of claim 1, wherein the polarization selective element is disposed behind the geometric phase modulator, the polarization selective element further being configured to convert the plurality of circular polarizations, which are output from the geometric phase modulator, to a plurality of linear polarizations corresponding to the plurality of circular polarizations, and output the plurality of linear polarizations to the image sensor, and
the image sensor being further configured to acquire an interference fringe generated by the plurality of linear polarizations as an image.

11. A method for generating a hologram, the method comprising:
modulating, by a geometric phase modulator, incident light from a target object to a plurality of circular polarizations;
receiving, by the image sensor, the plurality of circular polarizations and acquiring an interference fringe generated by the plurality of circular polarizations as an image; and
outputting, by a polarization selective element equipped with a liquid crystal element which controls an output polarization angle of the incident light according to an output polarization signal, sequentially the incident light at output polarization angles different from each other.

12. The method of claim 11, wherein the polarization selective element is sequentially disposed in a travel direction of the incident light and is configured as a plurality of cells set to output the incident light at polarization angles different from each other.

13. The method of claim 12, wherein each of the plurality of cells is configured as a liquid crystal element having a half-wave plate characteristics and is controlled to have a same phase in a whole area.

14. The method of claim 12, wherein the outputting sequentially of the incident light at the output polarization angles comprises:
applying an independent cell control signal to each of the plurality of cells as the output polarization signal; and
determining the output polarization angles according to the cell control signal applied to the each of the plurality of cells.

15. The method of claim 11, wherein the outputting sequentially of the incident light at the output polarization angles further comprises generating the output polarization signal in order to sequentially control an output polarization angle of the incident light at a 90-degree interval.

16. The method of claim 11, wherein the acquiring of the image comprises receiving the plurality of circular polarizations based on an exposure start signal of the image sensor, and
wherein the outputting sequentially of the incident light at the output polarization angles further comprises generating the output polarization signal to be synchronized with the exposure start signal.

17. The method of claim 11, wherein the plurality of cells is configured as a liquid crystal element having a same liquid crystal mode, and
wherein the liquid crystal mode employs anyone of an OCB mode, an ECB mode, a TN mode, a VA mode, and an IPS mode.

18. The method of claim 11, wherein the modulating to the plurality of circular polarizations comprises modulating the incident light, which is sequentially output at output polarization angles different from each other, to the plurality of circular polarizations respectively when the polarization selective element is disposed in front of the geometric phase modulator.

19. The method of claim 18, further comprising a linear polarizer disposed between the geometric phase modulator and the image sensor and further comprising shifting, by the linear polarizer, the plurality of circular polarizations to a plurality of linear polarizations, before the acquiring of the image,
wherein the acquiring of the image comprises acquiring an interference fringe generated by the plurality of linear polarizations as the image.

20. A polarization selective element, the polarization selective element comprising a liquid crystal element composed of a plurality of cells, which are sequentially disposed in a travel direction of incident light, in order to control output polarization angles of the incident light from a target object according to an output polarization signal,
wherein the polarization selective element outputs sequentially the incident light at the output polarization angles different from each other, which are determined based on a cell control signal as the output polarization signal applied independently to each of the plurality of cells.
